(19) United States
(12) Patent Application Publication
(10) Pub. No.: US 2007/0119959 A1
(43) Pub. Date: May 31, 2007

(54) Method and device for air-conditioning at stop position

(76) Inventor: Herbert Wieszt, Grafenau (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/552,139

(22) PCT Filed: Mar. 11, 2004
(86) PCT No.: PCT/EP04/02491

§ 371 Date: Nov. 21, 2006

(30) Foreign Application Priority Data
Apr. 9, 2003 (DE) 103 16 106.6

(51) Int. Cl. G05D 23/12; F25D 21/00; F25B 29/00

(52) U.S. Cl. 236/1 C; 165/232; 165/254

(57) ABSTRACT

A method and a device for stationary-mode air conditioning ensure that air conditioning measures take place only during a minimum time period before the arrival of the user at the vehicle so that an unnecessary consumption of resources is prevented. Furthermore, the user is no longer encumbered with having to estimate or calculate himself the necessary time during which an air conditioning measure has to take place in order to attain a desired air conditioning state at the time of arrival at the vehicle. For this purpose, an air conditioning assistant is constructed which, in response to an arrival time which has been input by a user and sensed climatic peripheral conditions, automatically causes an air conditioning measure to be started only for a necessary minimum time period before the arrival time which has been input. As a result of this, and by a suitable selection of the air conditioning measures used, it is possible to achieve a saving in resources.

### BACKGROUND AND SUMMARY OF THE INVENTION

This invention relates to a method and device for stationary-mode air conditioning.

Methods and devices for stationary-mode air conditioning in which the starting time of the selected system can be input by programming are known from the prior art.

For example, German document DE 43 15 379 discloses a heating system of a vehicle in which a heating device which is independent of the engine can be activated either by means of a preselection clock or by remote radio control. It is possible for an immediate start to take place or for a heating starting time at which a preset heating period, for example 30 or 60 minutes, starts, to be programmed.

German document DE 195 48 548 A1 discloses an auxiliary heating device which can be activated by means of a remote control system and in which as a rule an immediate heating start instruction is input or a heating start time is programmed on a portable transmission unit. In the vehicle, a small operator control switch is provided which is used to activate the auxiliary heating device if the portable transmitter unit is forgotten. In this system, an air conditioning control unit checks whether a passenger compartment actual temperature is higher than a predefined setpoint temperature. If this is the case, the control unit does not issue an instruction to the auxiliary heating device, but instead alternatively activates a stationary-mode ventilation process by means of a fan and/or by opening a sunroof, if one is present. The running time of the auxiliary heating device after its heating start can be set with this system.

German document DE 40 08 900 A1 discloses a method for controlling a heating and air conditioning system with an auxiliary heating device in a motor vehicle. In this method, two stationary operating modes are differentiated. In both stationary operating modes, the functions are carried out automatically, i.e. with air distributor flaps and a corresponding heater blower setting, and the running time of the respective heating functions are assigned and set automatically. In the first stationary heating operating mode, the temperature of the passenger compartment follows a predefined setpoint value characteristic curve as a function of the external temperature. The temperature characteristic curve is predominantly what is referred to as a “bathtub curve”. The second stationary heating operating mode is an immediate heating mode by means of preprogrammed timed heating of the passenger compartment and of the engine to a predefined maximum temperature value of the passenger compartment. This heating mode is limited to approximately 60 min. In both stationary heating operating modes, the blower settings and the distributor flaps are each assigned automatically, with a manual intervention also being possible. The user does not need to consider complicated relationships between air distribution and air quantity and switch-on period (battery). In addition, the battery is protected since the switch-on period is limited by the respective assignment.

In addition, German document DE 44 26 610 A1 discloses a stationary-mode heater for motor vehicles having a programmable control unit by means of which the desired departure time can be programmed. The control unit determines, as a function the desired departure time, the necessary switch-on time; in particular, it determines the switch-on time as a function of the external temperature and/or as a function of the programmed passenger compartment temperature of the vehicle which is desired at the departure time. In this way, an optimum heating period in terms of comfort and consumption of energy is determined.

In the stationary-mode heaters described above, at the starting time for heating there are still peripheral conditions, for example the temperature of the engine cooling water, the state of the battery, the fuel supply, the solar radiation, etc., which are not taken into account. The heating of the passenger compartment is controlled as a function of the external temperature only in the latter method. However, in the latter method the external temperature is taken into account in such a way that, for example, it is possible to shorten the heating time, i.e. shift the start of heating so that only then a later start of heating of the auxiliary heating device is possible; in contrast, in the penultimate method the heating power is merely adapted.

The object of the present invention is therefore to develop a method and a device for stationary-mode air conditioning in such a way that, when a stationary-mode air conditioning system starts on the basis of a preset starting time, climatic peripheral conditions such as the external temperature, the solar load, etc., and information about operating means and resources such as, for example, the temperature of the engine cooling water, the state of the battery, the fuel supply, etc., are taken into account. These conditions and this information are taken into account in such a way that, before the user reaches the vehicle, the shortest possible period of air conditioning with simultaneously the most suitable operating means and the lowest possible energy consumption is selected and, as a result, it is possible to achieve a saving in resources accompanied by the highest possible efficiency.

This object is achieved according to the invention by a method for stationary-mode air conditioning as claimed and a device for stationary-mode air conditioning as claimed. Advantageous developments of the invention are specified in dependent claims.

In particular, the method according to the invention and the device according to the invention make it possible to select the most suitable operating means and save resources by means of situation-adapted operating times. In addition, an optimum, balanced climatic result is achieved.

In addition, for the user, the programming of the stationary-mode air conditioning is significantly simplified since it is no longer necessary to engage in computing-related considerations for determining the air conditioning starting time to be input from the arrival time at the vehicle minus estimated duration of the air conditioning measure; all that is necessary is to input the arrival time at the vehicle.

This object and further objects, features and advantages of the present invention become clear from the following detailed description of a preferred exemplary embodiment of the invention which are described below in conjunction with the drawings.

### BRIEF DESCRIPTION OF THE DRAWINGS

FIG. 1 is a flowchart of an inventive method for stationary-mode air conditioning, and

FIG. 2 is a block circuit diagram of an inventive device for stationary-mode air conditioning.

### DETAILED DESCRIPTION OF THE INVENTION

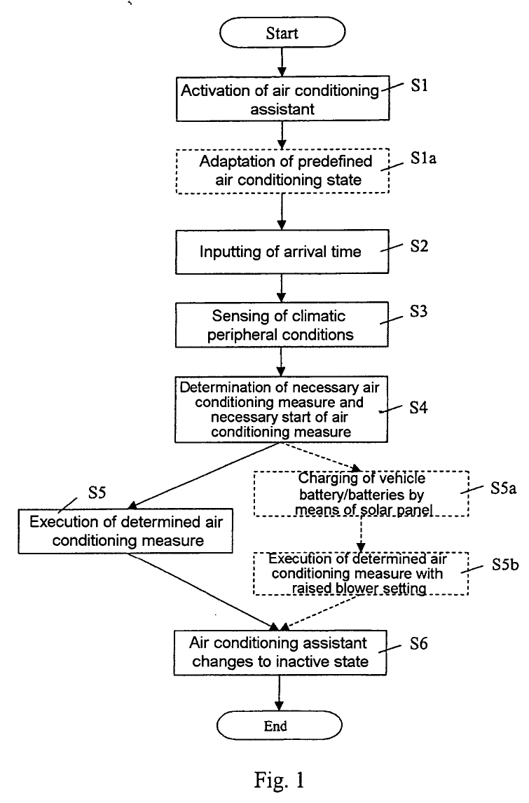

A preferred exemplary embodiment of the inventive method for stationary-mode air conditioning will be described in more detail with reference to FIG. 1.

FIG. 1 is a flowchart of a method according to the invention for stationary-mode air conditioning.

Firstly, in step S1 the user activates an air conditioning assistant and inputs a desired arrival time of the user at the vehicle, at which time a preset air conditioning state is to be reached (step S2). The preset air conditioning state can either be an air conditioning state which is predefined, for example, at the works, an air conditioning state which is set automatically during the driving mode or an air conditioning state which is adapted individually by the user in a step S1a.

During a predefined minimum time period before the time of arrival of the user, climatic peripheral conditions such as, for example, an external temperature, a solar load, an engine temperature and a passenger compartment temperature of the vehicle are sensed continuously (step S3). In response to the arrival time which has been input in step S2 and the climatic peripheral conditions which are sensed in step S3, in step S4 a control device contained in the air conditioning assistant determines, from the user's arrival time which has been input in step S2 and the climatic peripheral conditions sensed in step S3, whether it is necessary to heat, cool or ventilate and when such an air conditioning measure must start in order to attain the preset air conditioning state at the starting time which has been input in step S2. This determination process is carried out at periodic intervals corresponding to the sensing intervals of the climatic peripheral conditions. Then, after the determined, necessary start of the air conditioning measure has been reached, the determined air conditioning measure is carried out automatically in a step S5. Then, the sequence ends after, in step S6, the air conditioning assistant 4 has changed over again into an inactive state after the arrival time which has been input in step S2 has been reached.

In a step S5a, the closed-loop control device can optionally also firstly cause a vehicle battery to be charged via a solar panel for up to a second predefined minimum time period before the arrival time which has been input in step S2, and then in a step S5b the closed-loop control device can cause the ventilation blower to be then operated from the battery during the second minimum time period before the arrival time during the air conditioning measure at a higher setting than without the charging of the vehicle battery via the solar panel which is carried out in step S5a, thus achieving better through ventilation than when there is continuous through ventilation at the lowest setting.

In step S4, in addition to the climatic peripheral conditions sensed in step S3 and the arrival time of the user which has been input in step S2, the closed-loop control device can also take into account the existing resource supply such as, for example, the existing fuel quantity, the charge state of the battery or batteries etc. If it is detected that the resource supply is particularly low, it is possible, for example, to prolong the charge time of the solar panel in step S5a. This is not shown in the flowchart in FIG. 1. Furthermore, in step S4 the closed-loop control device selects the air conditioning means present in the air conditioning device in a selective fashion such that the desired air conditioning state is attained at the arrival time with the smallest possible consumption of resources.

With the method according to the invention, when the air conditioning means are retrofitted it is easily possible to cause them to be additionally taken into account by the closed-loop control device of the air conditioning assistant.

For the user, the operation of the air conditioning device which is operated with the method according to the invention is simple since it merely requires a user interface via which he indicates his arrival time and, if appropriate, the desired air conditioning state if he is not satisfied with a preset air conditioning state such as is automatically set, for example, during the driving mode. With the inventive method for air conditioning the user does not need to think about selecting the air conditioning means to be used or about the current peripheral conditions.

In addition to the selection and actuation of the air conditioning means in order to attain a predefined air conditioning state at the preselected arrival time, the closed-loop control device can optionally also open or close windows and/or a sunroof automatically, which is helpful in particular at very high temperatures in the passenger compartment of the vehicle, for example owing to intense solar radiation and moderate external temperatures.

The closed-loop control device may, for example, actuate the following air conditioning means: a blower for ventilating, a device for stationary-mode air conditioning by means of an electric compressor, a stationary-mode heater which is operated by burning fossil fuels, shading devices for the windows etc. In this context, the closed-loop control device may, for example, control the charging of the vehicle battery by means of solar cells in order to store energy for later ventilation or cooling, control the supply of the blower for ventilation via the battery, bring about actuation of the stationary-mode air conditioning via an electric compressor, cause the stationary-mode heater to operate by means of an internal combustion engine and, for example, cause roller blinds on the windows to be activated (closing or opening) or cause electrically shadeable windows to be actuated.

Of course, for a person skilled in the art it is self evident that air conditioning means other than those stated above can also be used and that then they are also actuated by means of the closed-loop control device.

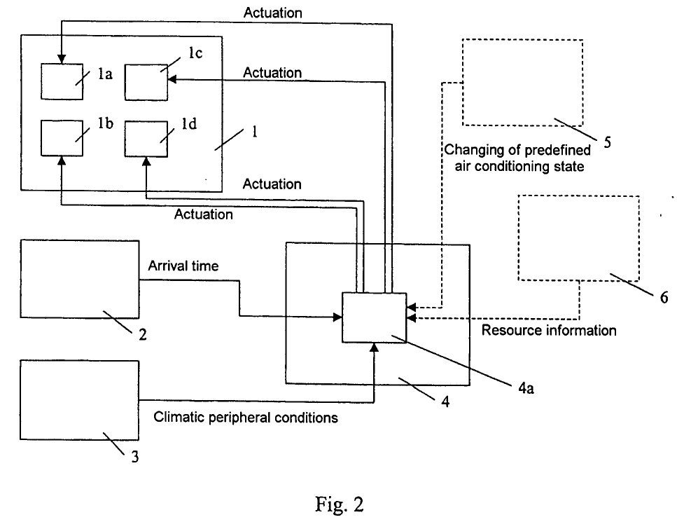

Details will now be given below on the design of the device according to the invention for stationary-mode air conditioning which is shown in a block circuit diagram in FIG. 2.

The inventive device for stationary-mode air conditioning has, inter alia, air conditioning means 1 for carrying out air conditioning measures during stationary-mode air conditioning. The air conditioning means 1 comprise, for example, a blower for ventilating la, an electric compressor for stationary-mode air conditioning 1b, a device for burning fossil fuels for operating a stationary-mode heater 1c, shading devices for the windows 1d such as, for example, roller blinds etc.

Furthermore, a device 2 for inputting an arrival time of a user at which a preset air conditioning state is to be reached, a device 3 for sensing climatic peripheral conditions and an air conditioning assistant 4 are constructed. The air conditioning assistant 4 has a control device 4a for determining which air conditioning measure of heating, cooling and/or ventilating is necessary and when this air conditioning measure must start in order to attain the preset air conditioning state at the arrival time. This determination is carried out taking into account the arrival time which has been input and the sensed climatic peripheral conditions. In accordance with the determination result, the closed-loop control device 4a causes the air conditioning means to start automatically at the determined starting time of the air conditioning measure.

Furthermore, a device 5 for manually adapting the preset air conditioning state is constructed for when the preset air conditioning state which can either be set at the works or transferred from the driving mode in accordance with the automatic setting is not used.

The device 3 for sensing climatic peripheral conditions senses, for example, an external temperature, a solar load, an engine temperature and/or a passenger compartment temperature of the vehicle. Of course, further parameters and/or different parameters can also be sensed and taken into account by means of the closed-loop control device 4a.

In order to achieve even better utilization of resources and a higher level of operational reliability, it is optionally also possible to construct a device 6 for sensing an existing resource supply and for outputting information about an existing resource supply. In this case, the closed-loop control device 4a for determining which air conditioning measure of heating, cooling and/or ventilating is necessary and for determining when this air conditioning measure is to start in order to attain the preset air conditioning state at the arrival time, takes into account, in addition to the arrival time which has been input and the climatic peripheral conditions, the information about an existing resource supply from the device 6 for sensing an existing resource supply. In this context, the closed-loop control device 4a receives, for example, information about the existing fuel quantity, the charge state of the battery or batteries etc. from the device 6 for sensing an existing resource supply.

In addition, the closed-loop control device 4a selects the air conditioning means 1 for carrying out the air conditioning measure in such a way that the preset air conditioning state is attained with the lowest possible consumption of resources at the arrival time which has been input. For example, when the closed-loop control device receives the information that there is only a small fuel quantity left, the closed-loop control device causes a vehicle battery to be charged by means of a solar panel, and an air blower to be subsequently charged by means of the previously charged vehicle battery, during a predetermined time before the start of the air conditioning measure. If the existing fuel quantity is sufficient, the closed-loop control device 4a can alternately shift the start of the air conditioning measure correspondingly closer to the arrival time and operate the ventilating blower with a higher blower setting. In addition, the closed-loop control device can automatically open the windows and/or a sunroof as an additional air conditioning measure which, depending on the air conditioning conditions, can shorten the air conditioning time and/or save energy and thus resources.

As a result, the construction of the air conditioning assistant and utilization of the sensing devices which are to a certain extent already present makes it possible for air conditioning measures to take place only during a necessary minimum time period before the arrival of the user at the vehicle, as a result of which an unnecessary consumption of resources is prevented. Furthermore, the user is no longer encumbered by the need to estimate or calculate himself the necessary time during which an air conditioning measure must take place in order to attain a desired air conditioning state at the time of arrival at the vehicle.

1-16. (canceled)

17. A method for stationary-mode air conditioning, comprising:
activating an air conditioning assistant,
inputting an arrival time of a user at which a preset air conditioning state is to be reached,
sensing climatic peripheral conditions and information about existing on-board means and resources,
determining with a closed-loop control device of the air conditioning assistant which air conditioning measure of heating, cooling and venting is necessary, and when this air conditioning measure has to start, from the arrival time which has been input, the climatic peripheral conditions, and information about existing on-board means and resources sensed, order to attain the preset air conditioning state at the arrival time, and which air conditioning device has or devices have to be selected in order to attain the preset air conditioning state at the arrival time with the on-board means which are most suitable and with a smallest possible consumption of resources, and
automatically starting the air conditioning device or the air conditioning devices at the beginning of the air conditioning measure determined, executing the air conditioning measure determined, and resetting the air conditioning assistant to an inactive state as soon as the arrival time which has been input is attained.

18. The method for stationary-mode air conditioning as claimed in claim 17, wherein manual adaptation of the preset air conditioning state is carried out.

19. The method for stationary-mode air conditioning as claimed in claim 17, wherein the preset air conditioning state is either an air conditioning state which is preset or an air conditioning state which is set automatically during driving.

20. The method for stationary-mode air conditioning as claimed in claim 17, wherein the sensing climatic peripheral conditions includes sensing at least one of an external temperature, a solar load, an engine temperature and a passenger compartment temperature of the vehicle.

21. The method for stationary-mode air conditioning as claimed in claim 17, wherein the information about existing on-board means and resources supply contains information about an existing fuel quantity or a charge state of a battery or batteries.

22. The method for stationary-mode air conditioning as claimed in claim 17, wherein a vehicle battery is charged via a solar panel during a predetermined time period before the start of the air conditioning measure, and wherein a ventilation blower is subsequently operated at a higher ventilation setting starting from a start of the air conditioning measure from the vehicle battery which has been charged.

23. The method for stationary-mode air conditioning as claimed in claim 22, wherein a charge time of the solar panel is lengthened if the information about existing on-board means and resources indicates that a resource supply is particularly low.

24. The method for stationary-mode air conditioning as claimed in claim 17, wherein the closed-loop control device brings about, as an air conditioning measure, any of ventilation by a blower, air conditioning by an electric compressor, heating by a fossil fuel burning device, and shading of the windows by roller blinds.

25. The method for stationary-mode air conditioning as claimed in claim 17, wherein the closed-loop control device brings about automatic opening or closing of at least one of a window and a sunroof in order to attain the preset air conditioning state more quickly, and selects the start of the air conditioning measure so that it is closer overall to the arrival time.

26. A device for stationary-mode air conditioning comprising:
air conditioning means for carrying out an air conditioning measure during the stationary-mode air conditioning,
a first device for inputting an arrival time of a user at which a preset air conditioning state is to be attained,
a second device for sensing climatic peripheral conditions,
a third device for sensing existing on-board means and resources and for outputting information about existing on-board means and resources, and
an air conditioning assistant having a closed-loop control device for determining which air conditioning measure of heating, cooling and ventilating is necessary and when this air conditioning measure has to begin in order to attain the preset air conditioning state at the arrival time,
wherein the air conditioning means is selected in order to attain the preset air conditioning state at the arrival time with the most suitable on-board means and a minimum possible consumption of resources from the arrival time which has been input and the sensed climatic peripheral conditions,
wherein the air conditioning means is automatically started at a determined starting time for the air conditioning measure, and
wherein the air conditioning assistant is automatically switched off as soon as the arrival time which has been input is attained.

27. The device for stationary-mode air conditioning as claimed in claim 26, and further comprising a device for manually adapting the preset air conditioning state.

28. The device for stationary-mode air conditioning as claimed in claim 26, wherein the second device senses at least one of an external temperature, a solar load, an engine temperature, and a passenger compartment temperature of the vehicle.

29. The device for stationary-mode air conditioning as claimed in claim 26, wherein the third device senses either an existing fuel quantity or a charge state of a battery or batteries.

30. The device for stationary-mode air conditioning as claimed in claim 26, wherein the closed-loop control device is constructed in such a way that, during a predetermined time period before the air conditioning measure starts, it can cause a vehicle battery to be charged by a solar panel and can subsequently cause a ventilation blower to be operated by the previously charged vehicle battery and shift the start of the air conditioning measure correspondingly closer to the arrival time.

31. The device for stationary-mode air conditioning as claimed in claim 26, wherein the air conditioning means comprises at least one of a blower for ventilating, an electric compressor for stationary-mode air conditioning, a fossil fuel burning device for operating a stationary-mode heater, and shading devices for windows.

32. The device for stationary-mode air conditioning as claimed in claim 26, wherein the closed-loop control device can automatically open at least one of a window and a sunroof as an additional air conditioning measure.

33. The device for stationary-mode air conditioning as claimed in claim 31, wherein the air conditioning means comprises the shading devices for windows, and wherein the shading devices are roller blinds.
